(19) United States
(12) Patent Application Publication
(10) Pub. No.: US 2026/0213381 A1
(43) Pub. Date: Jul. 23, 2026

(54) POWER STORAGE DEVICE

(71) Applicant: TOYOTA JIDOSHA KABUSHIKI KAISHA, Toyota-shi (JP)

(72) Inventors: Shuichi Nishida, Toyota-shi (JP); Hiroyuki Nakayama, Okazaki-shi (JP)

(73) Assignee: TOYOTA JIDOSHA KABUSHIKI KAISHA, Toyota-shi (JP)

(21) Appl. No.: 19/411,903

(22) Filed: Dec. 8, 2025

(30) Foreign Application Priority Data
Jan. 14, 2025 (JP) 2025-004999

(51) Int. Cl. H01M 50/588; H01M 10/0585; H01M 10/42; H01M 10/613; H01M 10/63; H01M 10/647; H01M 10/654; H01M 10/6568; H01M 50/105; H01M 50/178; H01M 50/691

(52) U.S. Cl. CPC H01M 50/588; H01M 10/0585; H01M 10/4228; H01M 10/613; H01M 10/63; H01M 10/647; H01M 10/654; H01M 10/6568; H01M 50/105; H01M 50/178; H01M 50/691

(57) ABSTRACT

A power storage device includes a battery module in which a laminated structure where a cathode layer and an anode layer face each other with a separator interposed therebetween, immersed in an electrolytic solution, is sealed in laminated packaging, with terminals electrically connected to each of the cathode layer and the anode layer protrude externally, a battery pack that accommodates the same, a cooling channel that circulates a non-conductive coolant in the periphery of the battery module for cooling, and a coolant discharging unit that, in response to leakage of electrolytic solution from the battery module detected by a leakage sensor detecting leakage, causes coolant to be discharged from the coolant channel to the periphery of the battery module, the power storage device configured such that the coolant mixes with the electrolytic solution leaked from the battery module in the battery pack, reducing conductivity of the electrolytic solution.

### CROSS-REFERENCE TO RELATED APPLICATION

This application claims priority to Japanese Patent Application No. 2025-004999 filed on Jan. 14, 2025. The disclosure of the above-identified application, including the specification, drawings, and claims, is incorporated by reference herein in its entirety.

### BACKGROUND

### 1. Technical Field

The present disclosure relates to a power storage device having a battery module, and more particularly relates to a structure for handling leakage of electrolytic solution from the battery module.

### 2. Description of Related Art

A power storage device having a battery module may be installed in a moving body or portable equipment and moved, and accordingly various configurations have been proposed to withstand impact to which the power storage device can be subjected while moving. For example, Japanese Unexamined Patent Application Publication No. 2023-177537 (JP 2023-177537 A) proposes a power storage device of a configuration including an power storage stack that includes a plurality of power storage modules arrayed in a first direction, a pair of restraining plates that clamps the power storage stack in the first direction, a pair of side wall portions that faces each other in a second direction orthogonal to the first direction such that the power storage stack is situated therebetween, and multiple stoppers that are each disposed between the power storage stack and the side wall portions on both outer sides of the power storage stack in the second direction, in which each of the restraining plates has an outer-side primary face that is situated opposite to a side on which the power storage stack is situated, and each of the outer-side primary faces of the restraining plates is provided with a plurality of reinforcing portions that extends in the second direction and also is aligned in a third direction orthogonal to the first direction and the second direction, and in which each of the stoppers is disposed at both end sides in the second direction of a corresponding one of the reinforcing portions, at a position that overlaps with the corresponding reinforcing portion in the first direction, so as to be able to suppress damage to the power storage stack when external impact is input.

### SUMMARY

A battery module of a secondary battery such as a lithium-ion secondary battery or the like is used as a power storage unit of a power storage device in some cases. There are various types of battery modules for such secondary batteries, and a typical liquid-based battery module is configured having a laminated structure formed in which a cathode active material layer applied to a current collector foil (cathode foil), which may be a metal foil, and an anode active material layer applied to a current collector foil (anode foil), which may be a metal foil, face each other with a separator in a state immersed in an electrolytic solution interposed therebetween, and the laminated structure is accommodated and sealed in a packaging made of a laminate material (laminate packaging). In this case, conductive regions that are electrically connected to the cathode foil and the anode foil are formed in regions of the packaging that face the cathode foil and the anode foil, respectively, and further, current collector plates to which a cathode terminal and an anode terminal that are externally electrically connected are attached, are each applied to the respective conductive regions. The battery module with the cathode terminal and the anode terminal attached thereto is then disposed and accommodated in an outer container (battery pack).

In the power storage device in which the battery modules are accommodated in the battery pack as described above, mechanical stress applied to the battery modules may cause the laminated packaging to tear and the electrolytic solution inside to leak out due to insufficient mechanical strength of the battery pack and inertial force, and when the cathode terminal and the anode terminal on the outside of the battery module become immersed in the electrolytic solution, electrical short-circuiting may occur. Accordingly, such a structure that suppresses electrical short-circuiting from occurring even when the cathode terminal and the anode terminal on the outside of the battery module are immersed in the electrolytic solution would be advantageous.

Thus, an object of the present disclosure is to suppress electrical short-circuiting

from occurring between the cathode terminal and the anode terminal on the outside of the battery module in the power storage device in which the above liquid-based battery module is accommodated in the battery pack, even when the electrolytic solution leaks from the laminate packaging of the battery module.

With respect to this point, in the above power storage device, there are cases in

which a structure for cooling the battery modules is accommodated together in the battery pack. Such a cooling structure typically involves forming a channel for a coolant in the periphery of the battery module, and absorbing heat by causing the coolant to flow through the channel. Such coolants are generally non-conductive liquids, and accordingly, in the event of leakage of the electrolytic solution to the outside of the battery module, an arrangement in which the coolant is also discharged into the battery pack so as to dilute the electrolytic solution that is leaking will enable electrical short-circuiting to be suppressed, even though the cathode terminal and the anode terminal become immersed in the electrolytic solution. This knowledge is employed in the present disclosure.

According to the present disclosure, the above object is achieved by a power storage device including a battery module in which a laminated structure, in which a cathode layer and an anode layer facing each other with a separator interposed between and an electrolytic solution filled in between the cathode layer and the anode layer is accommodated in and sealed in a laminate packaging, with terminals electrically connected to each of the cathode layer and the anode layer protruding externally, a battery pack that is an outer container for accommodating the battery module, and a cooling structure including a coolant channel that is disposed in a periphery of the battery module within the battery pack, the cooling structure being configured such that a coolant, that is non-conductive, flowing through the coolant channel absorbs heat from the battery module, the power storage device including
a leakage sensor that detects leakage of the electrolytic solution from the battery module, and
a coolant discharging unit for causing the coolant to be discharged from the coolant channel to the periphery of the battery module within the battery pack, in response to detection of leakage of the electrolytic solution by the leakage sensor, in which
the power storage device is configured such that, when the electrolytic solution leaks from the battery module, the electrolytic solution that is leaking is mixed with the coolant discharged from the coolant channel, reducing conductivity of the electrolytic solution.

In the above configuration, the term “battery module” may typically be a module formed by accommodating and sealing a liquid-based secondary battery such as a lithium-ion secondary battery or the like in laminate packaging. Here, the secondary battery is, in a normal form, a laminated structure in which a cathode layer and an anode layer are formed by coating a cathode foil and an anode foil with a cathode active material layer and an anode active material layer, respectively, and the cathode layer and the anode layer face to each other with a separator interposed therebetween, and an electrolytic solution is filled in therebetween, and a cathode terminal and an anode terminal electrically connected to the cathode foil and the anode foil, respectively, are provided outside the laminate packaging. The cathode foil, the cathode active material layer, the anode foil, the anode active material layer, the separator, and the electrolytic solution may be formed in a normal form. Typically, a configuration is adopted in which conductive regions are formed on faces of the laminate packaging facing the cathode foil and the anode foil, and current collector plates provided with terminals for external electrical connection are applied to these conductive regions, but this is not limiting. The battery module is then disposed in a battery pack, which is an outer container, and also a cooling structure is formed in the battery pack by disposing a coolant channel through which a coolant that is non-conductive flows in the periphery of the battery module to cool the battery module. The coolant may be, for example, a non-conductive liquid of which the main component is ethylene glycol, to which an anti-rust agent or the like has been added, or may be automatic transmission fluid (ATF). The liquid temperature is typically around 30° C., and cooling is carried out such that the battery temperature is 65° C. or lower, to suppress decrease in battery performance.

In the case of the present disclosure, the configuration of the power storage device in which the battery module and the cooling structure are disposed in the battery pack configured as described above further is provided with the leakage sensor that detects leakage of electrolytic solution from the battery module, and the coolant discharging unit that, in response to the detection of leakage of the electrolytic solution by the leakage sensor, causes the coolant to be discharged from the coolant channel to the periphery of the battery module in the battery pack. Here, the leakage sensor may be any type of sensor that detects contact with the electrolytic solution. Specifically, for example, this may be of a type that is made up of two metal members or metal wires, and when a conductive liquid adheres between the electrodes, a small current flows, whereby the contact of the conductive liquid can be detected. Thus, when the leakage sensor detects contact with the electrolytic solution, leakage of the electrolytic solution from the battery module is detected. When the leakage sensor detects leakage of the electrolytic solution, the information is then conveyed to the coolant discharging unit, and the coolant is discharged from the coolant channel to the periphery of the battery module in the battery pack, and the electrolytic solution that is leaking is mixed with the coolant flowing out from the coolant channel, thereby reducing the conductivity of the electrolytic solution.

According to the above-described configuration of the present disclosure, when the electrolytic solution leaks out from the battery module for some reason, the coolant is discharged from the coolant channel into the battery pack and mixes with the electrolytic solution that is leaking, thereby reducing the conductivity of the electrolytic solution, and accordingly, even when the electrolytic solution that is leaking comes into contact with the cathode terminal and the anode terminal on the outside of the laminate packaging, electrical short-circuiting can be circumvented.

In the above configuration, the coolant discharging unit may be a solenoid valve provided on the coolant channel, and the solenoid valve may be configured to discharge the coolant flowing through the coolant channel to outside of the coolant channel in response to detection of leakage of the electrolytic solution by the leakage sensor. Typically, the coolant channel is made up of an inlet channel for drawing in the coolant from outside the battery pack, a channel (heat exchange channel) that circulates the coolant along the outer face of the battery module so as to exchange heat with the face of the battery module, and an outlet channel that then sends the coolant out of the battery pack, and the solenoid valve may be provided on the inlet channel or the outlet channel, and may be configured to circulate the coolant through the heat exchange channel in normal operations, and to switch the flow of the coolant such that, when electrolytic solution leaks out from the battery module, the coolant is discharged from the inlet channel or the outlet channel to the periphery of the battery module.

In the above configuration, the leakage sensor can be provided at various parts. For example, the leakage sensor may be provided on a portion of a bottom face of the battery pack, or along an entire periphery of the battery module. The electrolytic solution leaking from the battery module first collects at the bottom face of the battery pack, and accordingly is expected that any leakage of the electrolytic solution from any part of the battery module can be detected more reliably. Also, the leakage sensor may be installed on a side portion of the battery module. Leakage of electrolytic solution from the battery module readily occurs at a sealing fused portion of the laminate packaging on the side portion of the battery module, and accordingly it is expected that by installing the leakage sensor on the side of the battery module, leakage of the electrolytic solution can be detected more quickly. Furthermore, leakage of the electrolytic solution may occur on a lower face of the battery module due to the laminate packaging being torn or the like, and accordingly the leakage sensor may be installed in a liquid trap formed on the bottom face of the battery pack on the lower side of the battery module, for detection thereof.

Thus, according to the configuration of the present disclosure, in a power storage device in which a liquid-based battery module is accommodated in a battery pack, even when electrolytic solution leaks from laminate packaging of the battery module, the electrolytic solution is diluted by the coolant, reducing conductivity thereof, and therefore, even when leaked liquid comes into contact with the cathode terminal and the anode terminal on the outside of the battery module, occurrence of electrical short-circuiting can be circumvented. The configuration of the present disclosure may be used in a power storage device using various types of liquid-based battery modules.

Other objects and advantages of the present disclosure will become apparent from the following description of preferred embodiments of the disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic cross-sectional view of one form of a power storage device to which an embodiment is applied;

FIG. 1B is a schematic top view of one form of the power storage device to which the embodiment is applied;

FIG. 1C is a schematic top view of another form of the power storage device to which the embodiment is applied;

FIG. 1D is a schematic top view of another form of the power storage device to which the embodiment is applied;

FIG. 2A is a schematic cross-sectional view of a form of the power storage device to which the embodiment is applied;

FIG. 2B is a schematic cross-sectional view of a form of the power storage device to which the embodiment is applied;

FIG. 2C is a schematic cross-sectional view of a form of the power storage device to which the embodiment is applied;

FIG. 2D is a schematic cross-sectional view of a form of the power storage device to which the embodiment is applied;

FIG. 3A is a schematic cross-sectional view of a further form of the power storage device to which the embodiment is applied;

FIG. 3B is a schematic top view of an adhesive layer that is downward from a current collector plate;

FIG. 4 is a schematic top view of yet another form of the power storage device to which the embodiment is applied;

FIG. 5A is a schematic cross-sectional view of the power storage device to which the embodiment is applied, illustrating operations when an electrolytic solution leaks from a battery module;

FIG. 5B is a schematic cross-sectional view of the power storage device to which the embodiment is applied, illustrating operations when the electrolytic solution leaks from the battery module; and

FIG. 5C is a schematic cross-sectional view of the power storage device to which the embodiment is applied, illustrating operations when the electrolytic solution leaks from the battery module.

### DETAILED DESCRIPTION OF EMBODIMENTS

The present disclosure will be described below in detail by way of a preferred embodiment with reference to the accompanying drawings. In the drawings, same reference numerals denote same parts.

### Basic Configuration of Power Storage Device

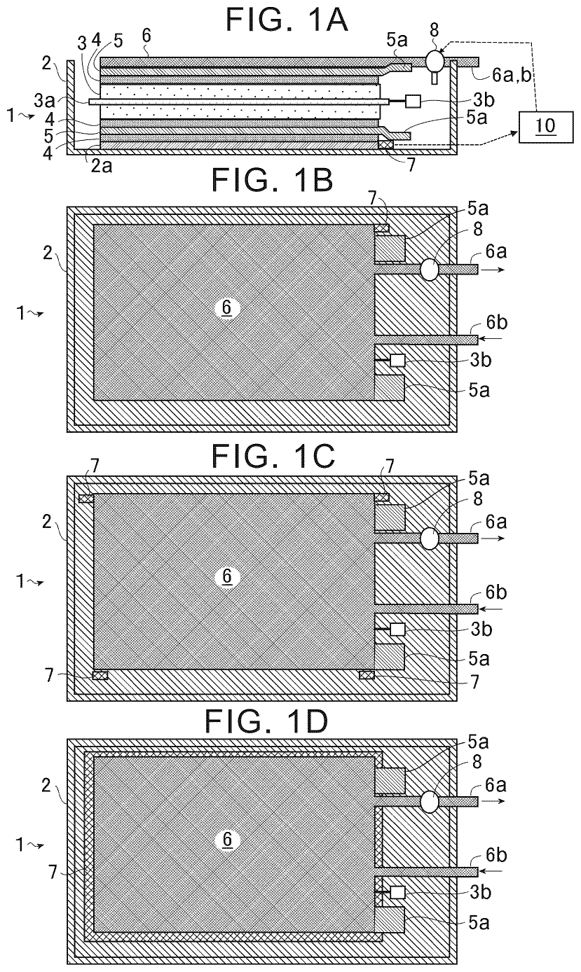

Referencing FIGS. 1A and 1B, a configuration of the present embodiment may

be applied to a configuration of a power storage device 1 in which a battery module 3, formed by accommodating and sealing a liquid-based secondary battery such as a lithium-ion secondary battery or the like in laminate packaging, is disposed on a bottom face on an inner side of a battery pack 2 serving as an outer container that has a barrel-like structure. More specifically, first, the battery module 3 may be configured in a normal form such that a laminated structure is obtained by a cathode layer and an anode layer, formed by coating a cathode foil and an anode foil with a cathode active material layer and an anode active material layer, respectively, facing each other with a separator interposed therebetween, and an electrolytic solution filled in therebetween, and the laminated structure is accommodated and sealed in laminate packaging. The cathode layer, the anode layer, the separator, and the electrolytic solution, may be prepared as those commonly used in this field. When sealing the laminated structure in the laminate packaging, typically, the laminated structure in a form of a thin plate is sandwiched between an upper portion of a laminate material formed to protrude upward in a thin box shape and a lower portion of the laminate material formed to protrude downward in a thin box shape, so as to be accommodated in the upper and lower box-shaped portions, and an edge of the upper portion and an edge of the lower portion are applied to each other and fused together to realize a sealed state in which the electrolytic solution in the laminated structure does not leak. The laminate material forming the laminate packaging may be a thin film material commonly used in this field, such as an aluminum foil with a resin layer applied to both sides thereof. Also, in a middle region of the laminate packaging, which forms an upper face and a lower face of the battery module 3, conductive foil is exposed, and current collector plates 5 having terminals 5a for external electrical connection are attached to the upper and lower conductive foils via adhesive layers 4 that are conductive. Note that the laminated structure in the battery module 3 may be formed by laminating a plurality of the battery cells, each made up of the cathode layer, the separator, and the anode layer, in a state of being connected in series, and in this case, a voltage monitor terminal 3b for monitoring voltage of each of the cells may be provided separately from the terminal 5a. The battery module 3 to which the current collector plates 5 are applied is then fixed to a support base portion 2a provided on the bottom face of the battery pack 2 by an additional adhesive layer 4 applied to the lower face of the current collector plate 5 on the lower side. Furthermore, a cooling plate 6 for cooling the battery module is disposed upward of the current collector plate 5 on the upper side. A coolant channel may be formed within the cooling plate 6, and coolant may be fed into the coolant channel from an inlet channel 6b, circulate within the cooling plate 6, absorb the heat generated by the battery module 3, and be sent to the outside from an outlet channel 6a. The coolant may be, for example, a non-conductive liquid of which the main component is ethylene glycol, to which an anti-rust agent or the like has been added, or may be automatic transmission fluid (ATF). The liquid temperature is typically around 30° C., and cooling is carried out such that the battery temperature is 65° C. or lower, to suppress decrease in battery performance. The terminals 5a attached to the current collector plates 5 are connected to external leads that are omitted from illustration, and charging/discharging of the battery is achieved through these leads.

### Configuration for Event of Electrolytic Solution Leakage

In the battery module 3 having the above-described configuration of the power storage device 1, the laminated structure making up the battery is sealed within the laminate packaging, and accordingly the electrolytic solution should not leak out of the battery module 3, but in the event of the power storage device 1 being subjected to mechanical impact or the like, causing a fused portion 3a of the laminate packaging of the battery module 3 to separate, or other parts to rupture, the electrolytic solution may leak out into the battery module 3, and in the event of the electrolytic solution coming into contact with the terminals 5a, electrical short-circuiting can occur. Accordingly, in the present embodiment, a structure is provided to circumvent electrical short-circuiting caused by the electrolytic solution leaking in this way.

Specifically, as illustrated in FIGS. 1A and 1B, a leakage sensor 7 that detects contact with the electrolytic solution, and an solenoid valve (coolant discharging unit) 8 that causes the coolant circulating within the cooling plate to be discharged to the periphery of the battery module 3 in response to the detection of contact with the electrolytic solution by the leakage sensor 7, are provided outside the battery module 3.

The leakage sensor 7 may be a sensor that detects contact with the electrolytic solution in an optional form. Typically, for example, as exemplified in the Summary of the Disclosure section, the device may be of a type that is made up of two metal members or metal wires, and when a conductive liquid adheres between the electrodes, a small current flows, thereby detecting the contact of the conductive liquid.

The leakage sensor 7 may be installed at various parts in the periphery of the battery module 3. In one form, the leakage sensor may be disposed on the bottom face of the battery pack 2, as illustrated in FIGS. 1A and 1B. As already mentioned, the electrolytic solution that leaks out collects on the bottom face of the battery pack 2, and accordingly, disposing the leakage sensor 7 on the bottom face of the battery pack 2 enables leakage of the electrolytic solution to be detected more reliably. Also, the disposing part may be near a part of the battery module 3 where the electrolytic solution is likely to leak, such as for example, in the vicinity of the corners of the battery module 3. Note that illustrated in FIG. 1C, leakage sensors 7 may be disposed at a plurality of locations such as the four corners or the like of the battery module 3, or as illustrated in FIG. 1D, may be disposed around substantially the entire perimeter of the battery module 3. Disposing the leakage sensors 7 only in the vicinity of parts where the electrolytic solution is likely to leak enables costs to be suppressed, while disposing the leakage sensors 7 around substantially the entire perimeter of the battery module 3 enables electrolytic solution leakage to be detected more reliably.

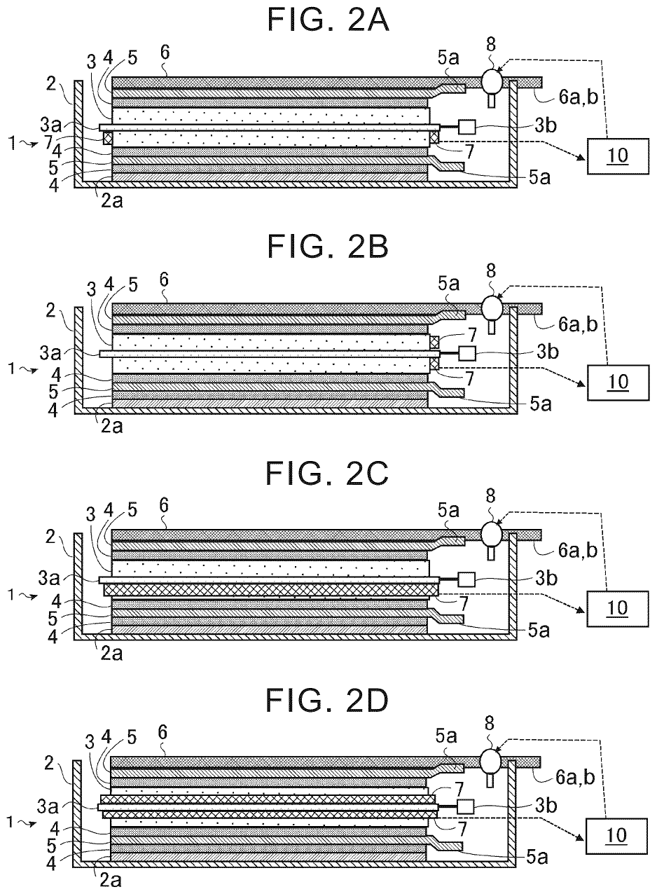

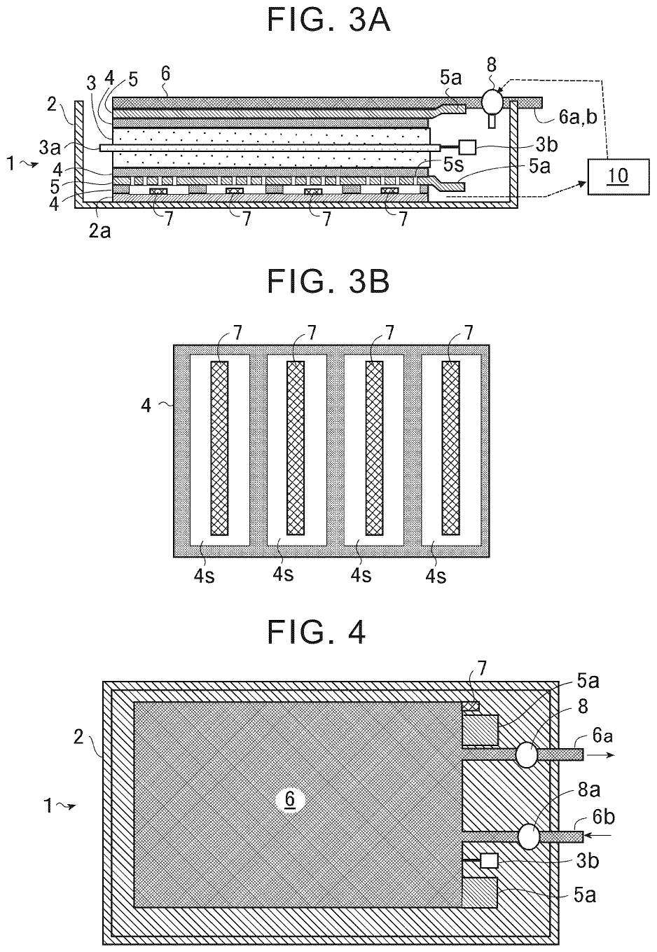

Also, as illustrated in FIGS. 2A and 2B, the leakage sensor 7 may be provided at an appropriate part on a lower side or an upper side of the fused portion 3a, on a side portion of the battery module 3, or as illustrated in FIGS. 2C and 2D, the leakage sensors 7 may be provided around the entire periphery on the lower side or the upper side of the fused portion 3a, on the side portion of the battery module 3. In the battery module 3, the electrolytic solution is likely to leak from the vicinity of the fused portion 3a, and accordingly, providing the leakage sensor 7 on the side portion of the battery module 3 enables leakage of the electrolytic solution to be detected more quickly.

Further, leakage of electrolytic solution can occur from the lower face of the battery module 3 as well, and accordingly, in order to perform detection thereof, a plurality of through holes 5s may be opened in the current collector plate 5 on the lower face of the battery module 3, and also liquid traps 4s may be formed in the adhesive layer 4 on the lower side of the current collector plate 5 on the lower face thereof, and leakage sensors 7 may be disposed in these liquid traps 4s. With this configuration, when leaking from the lower face of the battery module 3, the electrolytic solution passes through the through holes 5s in the current collector plate 5 on the lower face thereof and accumulates in the liquid traps 4s, and comes into contact with the leakage sensors 7 thereat, whereby the leakage of the electrolytic solution is detected.

Referring again to FIGS. 1A and 1B, when the electrolytic solution leaks out from the battery module 3 and comes into contact with the above leakage sensor 7, and the leakage of electrolytic solution is detected, this information is transmitted to a control unit 10 in an optional format, and the control unit 10 transmits a control command to the solenoid valve 8 provided on the outlet channel 6a or the inlet channel 6b for the coolant. The control unit 10 may be any type of electronic circuit device or electrical circuit device that is capable of receiving signals from the sensor 7 and transmitting control commands to the solenoid valve 8. Upon receiving the control command, the solenoid valve 8 causes the coolant flowing through the outlet channel 6a or the inlet channel 6b to be discharged to the periphery of the battery module 3 within the battery pack 2. Note that the solenoid valve 8 may be provided just on the outlet channel 6a, but as illustrated in FIG. 4, but may also be provided on the inlet channel 6b as well, which enables the coolant to be discharged to the periphery of the battery module 3 more quickly.

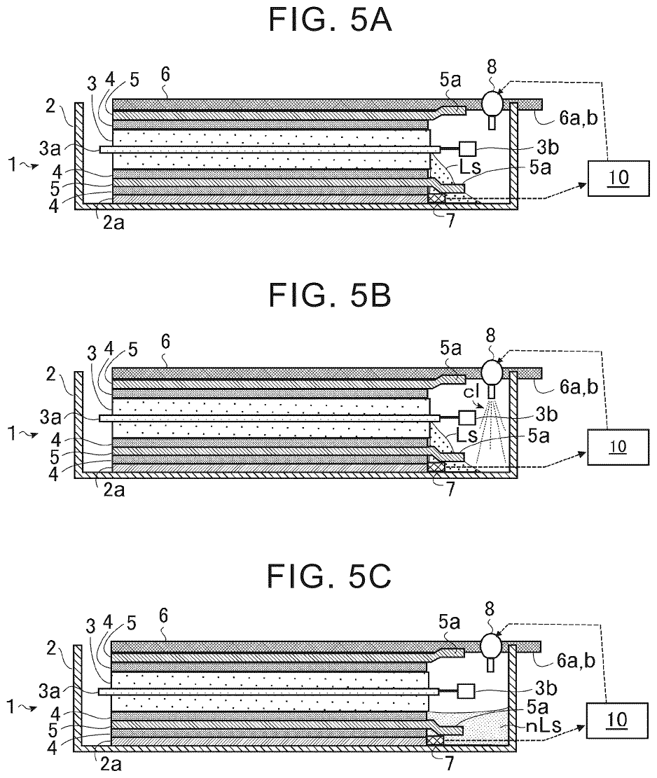

In the process from leakage of the electrolytic solution to dilution of the electrolytic solution by the coolant, first, as illustrated in FIG. 5A, electrolytic solution Ls that has leaked from the battery module 3 comes into contact with the leakage sensor 7, and this information is transmitted to the control unit 10. Accordingly, a control command is sent from the control unit 10 to the solenoid valve 8, and the solenoid valve 8 releases coolant cl within the battery pack 2, as illustrated in FIG. 5B. Thus, as illustrated in FIG. 5C, the electrolytic solution that leaked and the coolant are mixed, and due to the coolant being a non-conductive liquid, the conductivity of the mixed liquid is significantly reduced, thereby enabling electrical short-circuiting between the terminals to be circumvented.

Thus, according to the present embodiment, in the power storage device in which the above-described liquid-based battery module is accommodated in the battery pack, when the electrolytic solution leaks out from the laminate packaging of the battery module, the electrolytic solution that is leaking is diluted by the coolant, making the mixed liquid non-conductive, and accordingly electrical short-circuiting can be suppressed from occurring even when the cathode terminal and the anode terminal on the outside of the battery module come into contact with the liquid.

Although the above description has been made in relation to the embodiments of the present disclosure, it will be apparent that many modifications and changes can be easily made by those skilled in the art, and the present disclosure is not limited to the above-described exemplary embodiment, but can be applied to various devices without departing from the concept of the present disclosure.

What is claimed is:

1. A power storage device including a battery module in which a laminated structure, in which a cathode layer and an anode layer facing each other with a separator interposed between and an electrolytic solution filled in between the cathode layer and the anode layer is accommodated in and sealed in a laminate packaging, with terminals electrically connected to each of the cathode layer and the anode layer protruding externally, a battery pack that is an outer container for accommodating the battery module, and a cooling structure including a coolant channel that is disposed in a periphery of the battery module within the battery pack, the cooling structure being configured such that a coolant, that is non-conductive, flowing through the coolant channel absorbs heat from the battery module, the power storage device comprising:
a leakage sensor that detects leakage of the electrolytic solution from the battery module; and
a coolant discharging unit for causing the coolant to be discharged from the coolant channel to the periphery of the battery module within the battery pack, in response to detection of leakage of the electrolytic solution by the leakage sensor, wherein
the power storage device is configured such that, when the electrolytic solution leaks from the battery module, the electrolytic solution that is leaking is mixed with the coolant discharged from the coolant channel, reducing conductivity of the electrolytic solution.

2. The power storage device according to claim 1, wherein the coolant discharging unit is a solenoid valve provided on the coolant channel, and the solenoid valve is configured to discharge the coolant flowing through the coolant channel to outside of the coolant channel in response to detection of leakage of the electrolytic solution by the leakage sensor.

3. The power storage device according to claim 1, wherein the leakage sensor is installed on a bottom face of the battery pack.

4. The power storage device according to claim 1, wherein the leakage sensor is installed on a side portion of the battery module.

5. The power storage device according to claim 1, wherein the leakage sensor is installed in a liquid trap fashioned on a bottom face of the battery pack on a lower side of the battery module.
